(19) United States
(12) Patent Application Publication
(10) Pub. No.: US 2025/0191212 A1
(43) Pub. Date: Jun. 12, 2025

(54) EDGE AND CLOUD COMPUTING ASSISTED OBJECT DETECTION FOR IMAGES

(71) Applicant: QUALCOMM Incorporated, San Diego, CA (US)

(72) Inventors: Kyle Chi GUAN, New York, NY (US); Dan VASSILOVSKI, Del Mar, CA (US); Gene Wesley MARSH, San Diego, CA (US); Marc ADAMS, El Cajon, CA (US)

(21) Appl. No.: 18/532,916

(22) Filed: Dec. 7, 2023

(51) Int. Cl. G06T 7/70; G06T 3/40

(52) U.S. Cl. CPC G06T 7/70; G06T 3/40

(57) ABSTRACT

Techniques and systems are provided for image processing. For instance, a process can include detecting a first object in an image using a first object detection machine learning model; upscaling the image to generate an upscaled image; generating a plurality of sub-images from the upscaled image based on the first object; performing object detection on the plurality of sub-images using a second object detection machine learning model to detect a second object; fusing locations of objects detected in the plurality of sub-images into a single object location; and outputting a location of the first object and second object in the upscaled image.

### FIELD

The present application is related to image processing. For example, aspects of the present application relate to systems and techniques for improving object detection performance for images (e.g., traffic camera images) with edge and cloud computing assistance.

### BACKGROUND

Increasingly, systems and devices (e.g., autonomous vehicles, such as autonomous and semi-autonomous cars, drones, mobile robots, mobile devices, extended reality (XR) devices, and other suitable systems or devices) include multiple sensors to gather information about the environment, as well as processing systems to process the information gathered, such as for route planning, navigation, collision avoidance, etc. One example of such a system is an Advanced Driver Assistance System (ADAS) for a vehicle. Sensor data, such as images captured from one or more cameras, may be gathered, transformed, and analyzed to detect objects (e.g., targets). Detected objects may be compared to objects indicated on a high-definition (HD) map for localization of the vehicle. While on-vehicle sensors may be used to gather sensor data for generating and/or updating HD maps, it may also be useful to prefill and/or update HD maps using non-vehicle based sensors.

Traffic cameras are a common, non-vehicle based sensor. Traffic cameras are widely deployed and may be used to continuously or near-continuously (e.g., periodically) monitor roadways, intersections, etc. Thus, techniques to leverage existing traffic cameras to provide information for updating HD maps may be useful.

### SUMMARY

Systems and techniques are described herein for image processing. The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, apparatuses, methods and computer-readable media for image processing are provided. In one illustrative example, an apparatus for image processing is provided. The apparatus includes at least one memory comprising instructions and at least one processor coupled to the at least one memory. The at least one processor is configured to: detect a first object in an image using a first object detection machine learning model; upscale the image to generate an upscaled image; generate a plurality of sub-images from the upscaled image based on the first object; perform object detection on the plurality of sub-images using a second object detection machine learning model to detect a second object; fuse locations of objects detected in the plurality of sub-images into a single object location; and output a location of the first object and second object in the upscaled image.

As another example, method for image processing is provided. The method includes: detecting a first object in an image using a first object detection machine learning model; upscaling the image to generate an upscaled image; generating a plurality of sub-images from the upscaled image based on the first object; performing object detection on the plurality of sub-images using a second object detection machine learning model to detect a second object; fusing locations of objects detected in the plurality of sub-images into a single object location; and outputting a location of the first object and second object in the upscaled image.

In another example, a non-transitory computer-readable medium having stored thereon instructions is provided. The instructions, when executed by at least one processor, cause the at least one processor to: detect a first object in an image using a first object detection machine learning model; upscale the image to generate an upscaled image; generate a plurality of sub-images from the upscaled image based on the first object; perform object detection on the plurality of sub-images using a second object detection machine learning model to detect a second object; fuse locations of objects detected in the plurality of sub-images into a single object location; and output a location of the first object and second object in the upscaled image.

As another example, an apparatus for image processing is provided. The apparatus includes: means for detecting a first object in an image using a first object detection machine learning model; means for upscaling the image to generate an upscaled image; means for generating a plurality of sub-images from the upscaled image based on the first object; means for performing object detection on the plurality of sub-images using a second object detection machine learning model to detect a second object; means for fusing locations of objects detected in the plurality of sub-images into a single object location; and means for outputting a location of the first object and second object in the upscaled image.

In some aspects, one or more of the apparatuses described herein can include or be part of an extended reality device (e.g., a virtual reality (VR) device, an augmented reality (AR) device, or a mixed reality (MR) device), a mobile device (e.g., a mobile telephone or other mobile device), a wearable device (e.g., a network-connected watch or other wearable device), a personal computer, a laptop computer, a server computer, a television, a video game console, or other device. In some aspects, the one or more apparatuses further includes at least one camera for capturing one or more images or video frames. For example, the one or more apparatuses can include a camera (e.g., an RGB camera) or multiple cameras for capturing one or more images and/or one or more videos including video frames. In some aspects, the one or more apparatuses includes a display for displaying one or more images, videos, notifications, or other displayable data. In some aspects, the one or more apparatuses includes a transmitter configured to transmit data or information over a transmission medium to at least one device. In some aspects, the processor includes a central processing unit (CPU), a graphics processing unit (GPU), a neural processing unit (NPU), or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an architecture of an image capture and processing system, in accordance with aspects of the present disclosure;

FIG. 2A is a diagram illustrating an example of a fully-connected neural network, in accordance with some examples of the present disclosure;

FIG. 2B is a diagram illustrating an example of a locally-connected neural network, in accordance with some examples of the present disclosure;

FIG. 2C is a diagram illustrating an example of a convolutional neural network, in accordance with some examples of the present disclosure;

FIG. 2D is a diagram illustrating an example of a deep convolutional network (DCN) for recognizing visual features from an image, in accordance with some examples of the present disclosure;

FIG. 3 is a block diagram illustrating an example deep convolutional network (DCN), in accordance with some examples of the present disclosure;

FIG. 4 is a block diagram illustrating a technique for object detection in relatively low quality and/or low-resolution images, in accordance with aspects of the present disclosure;

FIG. 5 illustrates sub-image generation, in accordance with aspects of the present disclosure;

FIG. 6A illustrates a data flow for executing the technique for object detection on edge servers, in accordance with aspects of the present disclosure;

FIG. 6B illustrates a data flow for executing the technique for object detection on edge servers, in accordance with aspects of the present disclosure;

FIG. 6C illustrates a data flow for executing the technique for object detection using edge and cloud servers, in accordance with aspects of the present disclosure;

FIG. 7A illustrates a data flow for executing the technique for object detection on edge servers, in accordance with aspects of the present disclosure;

FIG. 7B illustrates a data flow for executing the technique for object detection on edge servers, in accordance with aspects of the present disclosure;

FIG. 7C illustrates a data flow for executing the technique for object detection using edge and cloud servers, in accordance with aspects of the present disclosure;

FIG. 8 is a flow diagram illustrating a process for processing image data, in accordance with aspects of the present disclosure;

FIG. 9 is a diagram illustrating an example of a system for implementing certain aspects of the present technology.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of subject matter of the application. However, it will be apparent that various examples may be practiced without these specific details. The figures and description are not intended to be restrictive.

The ensuing description provides illustrative examples only, and is not intended to limit the scope, applicability, or configuration of the disclosure. Rather, the ensuing description will provide those skilled in the art with an enabling description for implementing the illustrative examples. It should be understood that various changes may be made in the function and arrangement of elements without departing from the spirit and scope of the application as set forth in the appended claims.

In some cases, high definition (HD) maps may be used by vehicles to help navigate through an environment. HD) maps are a fundamental component of many vehicles (e.g., autonomous and/or semi-autonomous vehicles) by encoding prior knowledge of all scenes (e.g., environment) an autonomous vehicle may encounter. An HD map may be three-dimensional (e.g., including elevation information). For instance, an HD map may include three-dimensional data (e.g., elevation data) regarding a three-dimensional space, such as a road on which a vehicle is navigating. In some examples, the HD map can include a plurality of map points corresponding to one or more reference locations in the three-dimensional space. In some cases, the HD map can include dimensional information for objects in the three-dimensional space and other semantic information associated with the three-dimensional space. For instance, the information from the HD map can include elevation or height information (e.g., road elevation/height), normal information (e.g., road normal), and/or other semantic information related to a portion (e.g., the road) of the three-dimensional space in which the vehicle is navigating.

An HD map may include a high level of detail (e.g., including centimeter level details). In the context of HD maps, the term “high” typically refers to the level of detail and accuracy of the map data. In some cases, an HD map may have a higher spatial resolution and/or level of detail as compared to a non-HD map. While there is no specific universally accepted quantitative threshold to define “high” in HD maps, several factors contribute to the characterization of the quality and level of detail of an HD map. Some key aspects considered in evaluating the “high” quality of an HD map include resolution, geometric accuracy, semantic information, dynamic data, and coverage. With regard to resolution, HD maps generally have a high spatial resolution, meaning they provide detailed information about the environment. The resolution can be measured in terms of meters per pixel or pixels per meter, indicating the level of detail captured in the map. With regard to geometric accuracy, an accurate representation of road geometry, lane boundaries, and other features can be important in an HD map. High-quality HD maps strive for precise alignment and positioning of objects in the real world. Geometric accuracy is often quantified using metrics such as root mean square error (RMSE) or positional accuracy. With regard to semantic information, HD maps include not only geometric data but also semantic information about the environment. This may include lane-level information, traffic signs, traffic signals, road markings, building footprints, and more. The richness and completeness of the semantic information contribute to the level of detail in the map. With regard to dynamic data, some HD maps incorporate real-time or near real-time updates to capture dynamic elements such as traffic flow, road closures, construction zones, and temporary changes. The frequency and accuracy of dynamic updates can affect the quality of the HD map. With regard to coverage, the extent of coverage provided by an HD map is another important factor. Coverage refers to the geographical area covered by the map. An HD map can cover a significant portion of a city, region, or country. In general, an HD map may exhibit a rich level of detail, accurate representation of the environment, and extensive coverage.

Often, HD maps may be generated and/or updated using vehicle-based sensors. However, gathering information for HD maps solely using vehicle-based sensors may be incur overhead and scaling costs, privacy concerns, and/or relatively long lag times between updates for a given area. In some cases, it may be useful to supplement information provided by vehicle-based sensors with information provided by non-vehicle based sensors, such as traffic cameras. Traffic cameras can be included in or part of various types of devices or objects, such as traffic lights, traffic signs, roadside units (RSUs), and/or other type of device or object. An RSU is a device that can transmit and receive messages over a communications link or interface (e.g., a cellular-based sidelink or PC5 interface, an 802.11 or WiFi™ based Dedicated Short Range Communication (DSRC) interface, and/or other interface) to and from one or more computing devices, other RSUs, network devices (e.g., base stations), and/or other devices. An example of messages that can be transmitted and received by an RSU includes vehicle-to-everything (V2X) messages. RSUs can be located on various transportation infrastructure systems, including roads, bridges, parking lots, toll booths, and/or other infrastructure systems. In some examples, an RSU can facilitate communication between user devices (e.g., vehicles, pedestrian user devices such as mobile phones or wearable devices, and/or other user devices) and the transportation infrastructure systems. In some implementations, a RSU can be in communication with a server, base station, and/or other system that can perform centralized management functions.

In some cases, using non-vehicle based sensors (e.g., existing traffic cameras) to provide information for HD maps can be challenging. For example, traffic cameras may be operated by a number of state and/or local transportation departments and image resolution and quality of images from these numerous sources can vary widely. Additionally, many traffic related objects, such as traffic lights, traffic signs, road markers, carriers, etc. may appear quite small in the images due to, for example, distance between the objects and the camera, field-of-view (FoV) coverage, preset zoom levels, and the like. While training a new machine learning (ML) model to recognize such targeted small objects may be feasible, it may be more cost effective and quicker to utilize pre-trained (e.g., existing) ML models, such as convolutional neural network (CNN) based ML models like RCNN, Faster RCNN, SSD, YOLO, etc., to detect relatively small objects (e.g., in terms of a number of pixels representing the object relative to the entire image) in the images provided by traffic cameras.

Systems, apparatuses, electronic devices, methods (also referred to as processes), and computer-readable media (collectively referred to herein as “systems and techniques”) are described herein for edge and cloud computing assisted object detection of relatively small objects (e.g., objects smaller than a size threshold, such as a number of pixels less than a threshold number of pixels) in relatively low resolution and/or low-quality images, such as images from traffic cameras. For example, relatively low quality and/or low-resolution images may be obtained from a non-vehicle based sensor (e.g., a traffic camera). The image(s) may be uploaded to an edge or cloud server. A first object detection ML model may be used to detect an object in the image(s). Each of the image(s) may also be upscaled, for example, by an upscaling ML model.

In some cases, a sub-image (e.g., a cropped image) of each upscaled image may be generated based on the detected object(s) in the image(s). For instance, multiple sub-images may be generated for a particular upscaled image based on multiple objects detected in the image (e.g., one cropped or sub-image around each object detected in the image). The sub-images may be provided as input to a second object detection ML model to perform object detection. Attempting to detect objects using sub-images of an upscaled image may allow the second object detection ML model to detect objects that were missed in the relatively lower resolution original image from which the upscaled image was generated. Objects detected in a particular sub-image may be associated with location information relative to the sub-image in which they were detected. For example, the location information may be in coordinates relative to the sub-image. The location information for the detected objects may be transformed into coordinates relative to the upscaled image. In some cases, performing object detection on a set of sub-images may result in an object being detected multiple times. These instances of the object may be fused into a single detected object for the upscaled image.

Various aspects of the application will be described with respect to the figures.

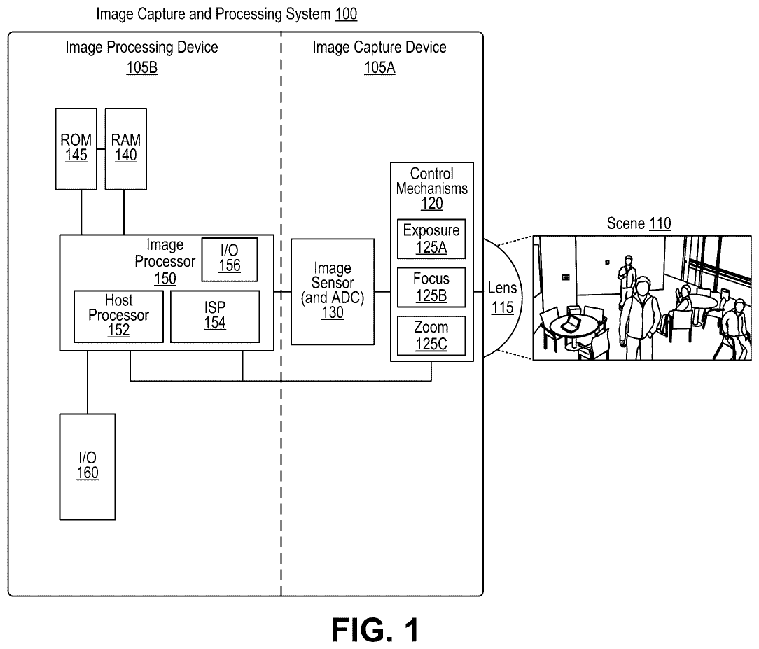

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. In some cases, the lens 115 and image sensor 130 can be associated with an optical axis. In one illustrative example, the photosensitive area of the image sensor 130 (e.g., the photodiodes) and the lens 115 can both be centered on the optical axis. A lens 115 of the image capture and processing system 100 faces a scene 110 and receives light from the scene 110. The lens 115 bends incoming light from the scene toward the image sensor 130. The light received by the lens 115 passes through an aperture. In some cases, the aperture (e.g., the aperture size) is controlled by one or more control mechanisms 120 and is received by an image sensor 130. In some cases, the aperture can have a fixed size.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and focus control mechanism 125B can be omitted without departing from the scope of the present disclosure.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, image processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter.

Returning to FIG. 1, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 130) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 130 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

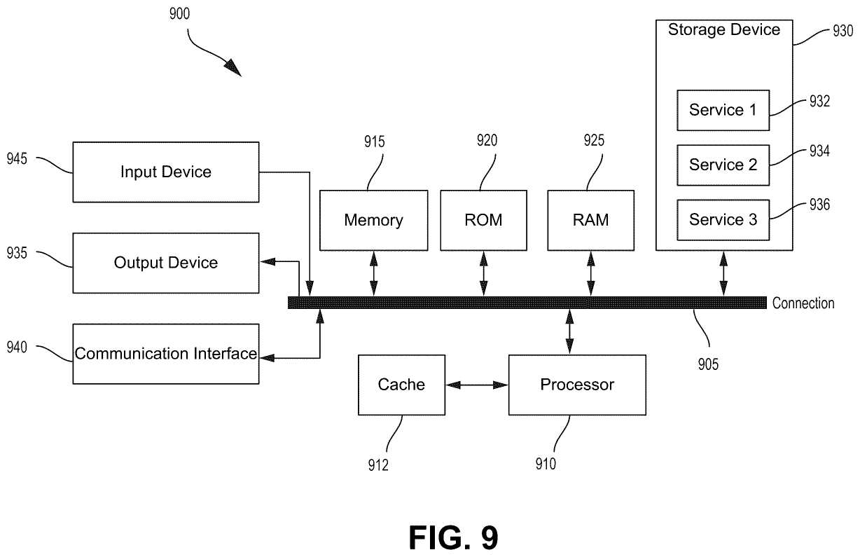

The image processor 150 may include one or more processors, such as one or more image signal processors (ISPs) (including ISP 154), one or more host processors (including host processor 152), and/or one or more of any other type of processor 1010 discussed with respect to the computing system 900 of FIG. 9. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as demosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1025, read-only memory (ROM) 145/1020, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices, any other input devices, or some combination thereof. In some cases, a caption may be input into the image processing device 105B through a physical keyboard or keypad of the I/O devices 160, or through a virtual keyboard or keypad of a touchscreen of the I/O devices 160. The I/O devices 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O devices 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.10 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

In some cases, images captured by the image capture and processing system 100 may be processed by neural networks and/or machine learning (ML) systems. A neural network is an example of an ML system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

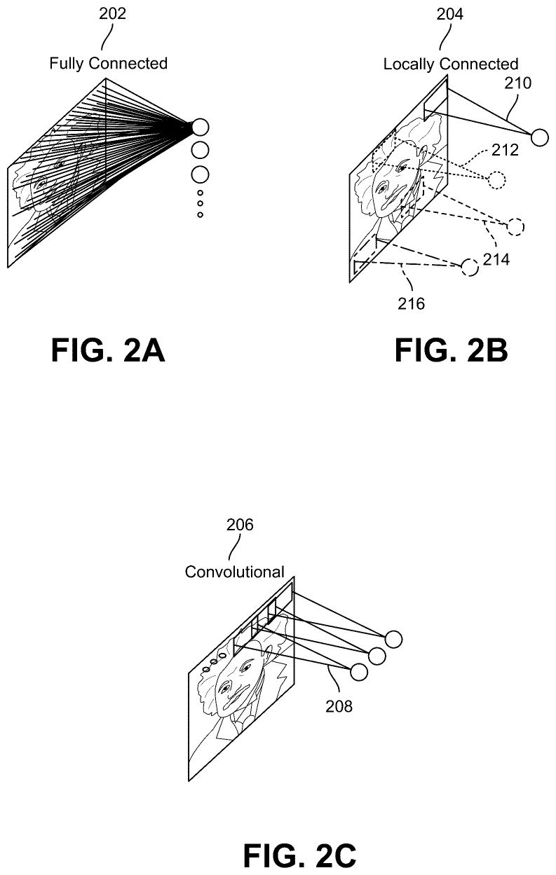

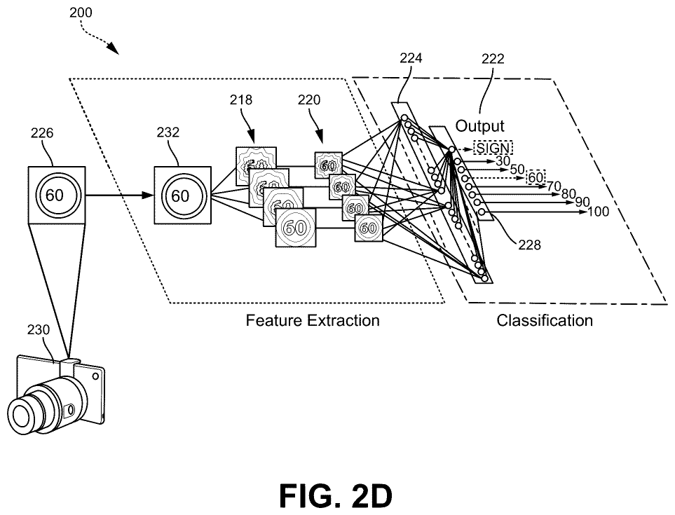

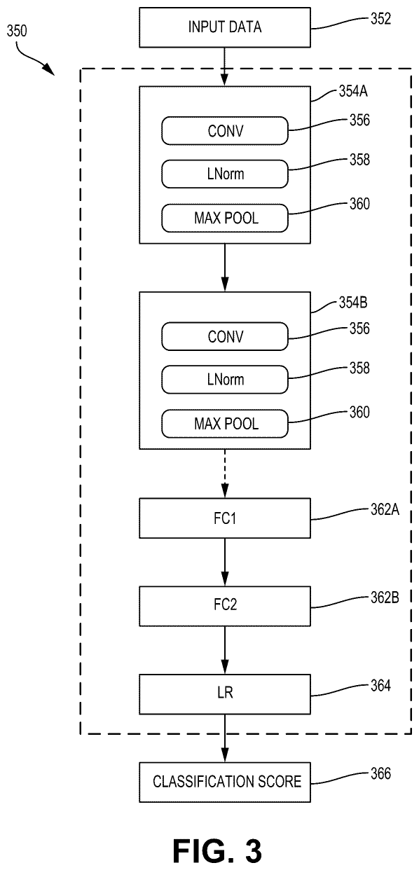

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. The connections between layers of a neural network may be fully connected or locally connected. Various examples of neural network architectures are described below with respect to FIG. 2A-FIG. 3.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful. Convolutional neural network 206 may be used to perform one or more aspects of video compression and/or decompression, according to aspects of the present disclosure.

One type of convolutional neural network is a deep convolutional network (DCN). FIG. 2D illustrates a detailed example of a DCN 200 designed to recognize visual features from an image 226 input from an image capturing device 230, such as a image capture and processing system 100 of FIG. 1. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., feature maps 220) receiving input from a range of neurons in the previous layer (e.g., feature maps 218) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction.

FIG. 3 is a block diagram illustrating an example of a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360. Of note, the layers illustrated with respect to convolution blocks 354A and 354B are examples of layers that may be included in a convolution layer and are not intended to be limiting and other types of layers may be included in any order.

The convolution layers 356 may include one or more convolutional filters, which may be applied to the input data 352 to generate a feature map. Although only two convolution blocks 354A, 354B are shown, the present disclosure is not so limiting, and instead, any number of convolution blocks (e.g., convolution blocks 354A, 354B) may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a processor such as a CPU or GPU, or any other type of processor 910 discussed with respect to the computing system 900 of FIG. 9 to achieve high performance and low power consumption. In alternative aspects, the parallel filter banks may be loaded on a DSP or an ISP of the computing system 900 of FIG. 9. In addition, the deep convolutional network 350 may access other processing blocks that may be present on the computing system 900 of FIG. 9, such as sensor processor and navigation module, dedicated, respectively, to sensors and navigation.

The deep convolutional network 350 may also include one or more fully connected layers, such as layer 362A (labeled “FC1”) and layer 362B (labeled “FC2”). The deep convolutional network 350 may further include a logistic regression (LR) layer 364. Between each layer 356, 358, 360, 362A, 362B, 364 of the deep convolutional network 350 are weights (not shown) that are to be updated. The output of each of the layers (e.g., 356, 358, 360, 362A, 362B, 364) may serve as an input of a succeeding one of the layers (e.g., 356, 358, 360, 362A, 362B, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

In some cases, one or more convolutional networks, such as a DCN, may be incorporated into more complex ML networks. As an example, as indicated above, the deep convolutional network 350 may output probabilities that an input data, such as an image, includes certain features. The deep convolutional network 350 may then be modified to extract (e.g., output) certain features. Additionally, DCNs may be added to extract other features as well. This set of DCNs may function as feature extractors to identify features in an image. In some cases, feature extractors may be used as a backbone for additionally ML network components to perform further operations, such as image segmentation.

As indicated above, HD maps may be used by vehicles to help navigate through an environment. For example, a vehicle may use a HD map for localization of the vehicle. Some cases, such as merging, exiting, navigating forks in a road, etc., may require more precise location information than available with satellite-based navigation systems. For example, location information, such as those obtained using satellite-based navigation system, may be used to determine a road on which the vehicle is travelling. However, such systems may not be able to precisely locate the vehicle on the road, such as in which portion of a lane the vehicle is in. Localization may be used to determine a precise position of the vehicle and localization may be based on highly detailed maps of the environment, such as an HD map. An HD map may be a highly detailed map that may include multiple layers of information corresponding to information sensors of the vehicle may detect or type of information provided by the layer. For example, an HD map may include a camera-oriented layer which may include images (or features that may be detected in images) that a camera may capture at a location. The camera-oriented layers may help provide information about features that may be difficult to obtain via other sensors, such as for lane markings.

In some cases, HD maps may be generated and/or updated using vehicle-based sensors. However, gathering information for HD maps solely using vehicle-based sensors may be incur overhead and scaling costs, privacy concerns, and/or relatively long lag times between updates for a given area. In some cases, it may be useful to supplement information provided by vehicle-based sensors with information provided by non-vehicle based sensors, such as traffic cameras. In some cases, traffic cameras may already be deployed at areas of interest such as intersections, areas where congestion may be common, major roadways, etc. and often traffic cameras can monitor these areas of interest continuously or near continuously. Thus, it may be useful to use image information from traffic cameras to generate and/or update HD maps. For example, traffic cameras may be able to provide information about intersections, traffic signal-to-lane associations, preferred vehicle traversal trajectories, road markings, signage, sidewalks, barriers, etc., as well as detect events/incidents, such as traffic accidents, construction activities, weather, etc.

Using existing traffic cameras to provide information for HD maps can be challenging. For example, traffic cameras may be operated by a number of state and/or local transportation departments and image resolution and quality of images from these numerous sources can vary widely. Additionally, many traffic related objects, such as traffic lights, traffic signs, road markers, carriers, etc. may appear quite small in the images due to, for example, distance between the objects and the camera, field-of-view (FoV) coverage, preset zoom levels, and the like. While training a new machine learning (ML) model to recognize such targeted small objects may be feasible, it may be more cost effective and quicker to utilize pre-trained (e.g., existing) ML models, such as CNN based ML models like RCNN, Faster RCNN, SSD, YOLO, etc., to detect relatively small objects (e.g., in terms of a number of pixels representing the object relative to the entire image) in the images provided by traffic cameras. For example, a “relatively small” object may include an object in an image represented by a number of pixels less than a threshold number of pixels (e.g., less than 10 pixels, 25 pixels, 50 pixels, or other threshold number of pixels). Moreover, the techniques discussed here may also be applied to new ML models that have been trained to recognize relatively small objects to enhance their efficacy, for example to work with relatively low resolution and/or low-quality images. While discussed in the context of traffic cameras, it should be understood that the concepts discussed herein may be applied to detect relatively small objects in relatively low resolution and/or low-quality images.

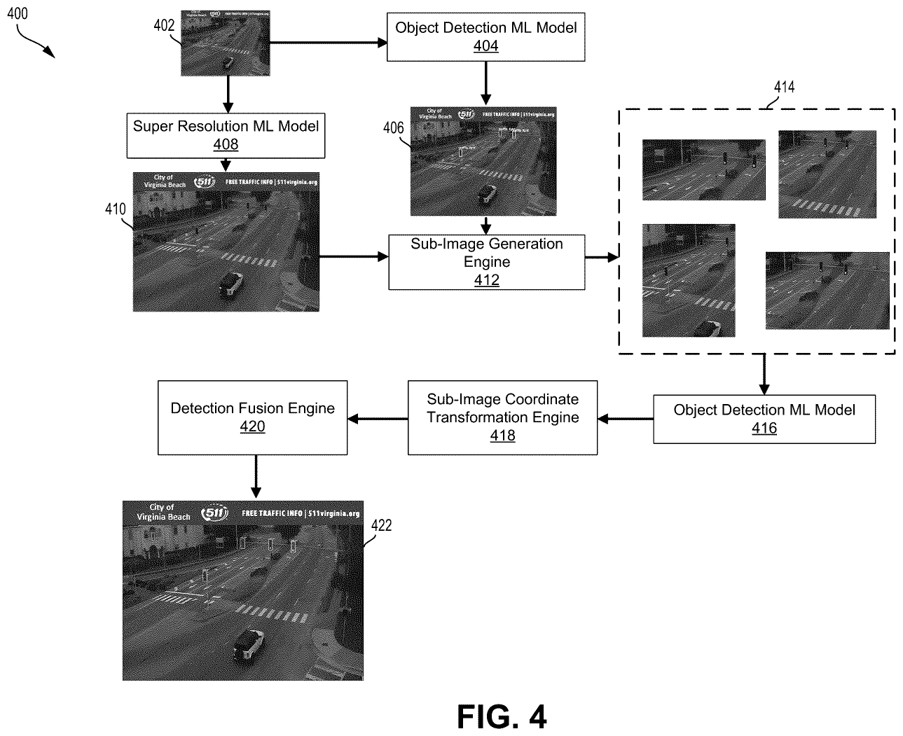

FIG. 4 is a block diagram illustrating a technique for object detection 400 in relatively low quality and/or low-resolution images, in accordance with aspects of the present disclosure. Initially, a relatively low quality and/or low-resolution original image 402 may be received. In this example, the original image 402 may be received from a traffic camera monitoring an intersection. The original image 402 may be input to one or more object detection models 404. The one or more object detection models may process the original image 402 to detect relevant objects, such as traffic cameras, road markings, characteristics of the road/intersection, traffic signs, etc. The relevant objects to be detected may be configurable. The one or more object detection models may be one or more ML models that have been trained (e.g., pretrained) to detect objects in an image and localize detected objects in an image. For example, the object detection model(s) 404 may detect an object and output an indication of the detected object (as shown in image 406), such as a bounding box, labels, etc., indicating where the detected object(s) is in the original image 402. The object detection model(s) 404 may also output classification labels for detected objects and/or an indication of detection confidence. In some cases, semantic segmentation or other ML models for detecting, locating, and/or identifying objects in images may be used.

In some cases, as the original image 402 may be relatively low quality and/or low resolution, the object detection ML models 404 may not detect every instance of an object in question and objects may be missed (e.g., miss detection). For example, as shown in image 406, not every traffic light is detected. However, in many cases, the objects of interest in a traffic camera image are often clustered together. For example, traffic lights are often found within the vicinity of other traffic lights (e.g., mounted on a common pole, along a same side of a street, etc. such that they are in a common portion of the traffic camera image). Thus, the object instances detected may be used to identify areas within the original image 402 that may include missed (e.g., undetected) objects. The output of the object detection model(s) 404 may be passed to a sub-image generation engine 412.

Returning to the original image 402, the original image 402 may also be input into one or more super resolution ML models 408. Super resolution ML models 408 (e.g., upscaling ML models) may upscale and/or enhance relatively low-quality/low-resolution images using ML based techniques. For example, ML/deep learning techniques may be applied to upscale relatively lower resolution images to relatively higher resolutions. These super resolution ML models 408 may also enhance these upscaled images by extrapolating details so that the upscaled images appear sharper and more detailed than the original images. Examples of such super resolution ML models 408 may include super-resolution convolutional neural network (SRCNN), generative adversarial network-based (GAN) super resolution models, and the like. In some cases, the specific super resolution ML model to be used may be configurable. In some cases, the original image 402 may be enlarged by a scale factor S, such that an original image 402 with a resolution of w×h may be enlarged by the super resolution ML models 408 to a higher resolution image 410 having a resolution of Sw×Sh. The higher resolution image 410 may be passed to the sub-image generation engine 412.

In some cases, the sub-image generation engine 412 may receive the indication of where detected object(s) are in the original image 402, along with classification labels and/or detection confidence indication (if available) from the object detection ML model(s) 404 and may receive the higher resolution image 410 from the super resolution ML model(s) 408. The sub-image generation engine 412 may generate a number K of cropped sub-images 414 from the higher resolution image 410 based on a number of indicated detected objects in the original image 402. In some cases, the number K of cropped sub-images 414, along with the shape/side of the cropped sub-images 414 may be tuned, for example, based on how well the object detection ML model(s) 404 can typically detect objects.

The cropped sub-images 414 may be passed into another object detection ML model(s) 416. The object detection ML model(s) 416 may be the same as object detection ML model(s) 404, or different object detection ML model(s). For example, the object detection ML model(s) 404 may be a relatively light-weight (e.g., less computing resource intensive) ML model, while object detection ML model(s) 416 may be a more sensitive ML model that may use relatively more computing resources, processing power, etc. In some cases, the object detection ML model(s) 404 and/or object detection ML models 416 may be configurable. The object detection ML model(s) 416 may process each sub-image of the cropped sub-images 414 to detect objects and the ML model(s) 416 may output an indication of a location (e.g., indicated location) of the detected objects, such as a bounding box, labels, etc., indicating where the detected object(s) is in the cropped sub-images 414. That is, for a particular sub-image, the ML model(s) 416 may output a location of a bounding box based on the coordinate system of the particular sub-image (e.g., x/y coordinate system based on the resolution of the sub-image).

As the indicated location of the detected objects is in a coordinate system of the cropped sub-images, the indicated location of the detected objects may be passed to a sub-image coordinate transformation engine 418. The sub-image coordinate transformation engine 418 may transform the indicated location of the detected objects in the cropped sub-images 414 from the coordinate system of the cropped sub-images 414 to a coordinate system of the higher resolution image 410. The transformed indicated location of the detected objects may be passed to the detection fusion engine 420. The detection fusion engine may fuse (e.g., integrate) the transformed indicated location of the detected objects from the sub-images into a single location. For example, a particular object may be detected multiple times, for example in multiple cropped sub-images 414. The multiple indicated location (e.g., bounding boxes, labelled pixels, segmentation map, etc.) of this particular object may be fused into a single indicated location. In some cases, this fusion may be based on an algorithm such as non-maximum suppression (NMS). In some examples, the type of fusion algorithm that may be used by the detection fusion engine 420 may be configurable. As an example, multiple overlapping indicated location may be associated with multiple detections of the same object and the indicated location associated with the highest detection confidence, as indicated by the object detection ML model(s) 416 may be used as the indicated location of the location of the object. The fused indicated location of the detected object and higher resolution image 422 may be output, for example, use by an ADAS and/or HD map system.

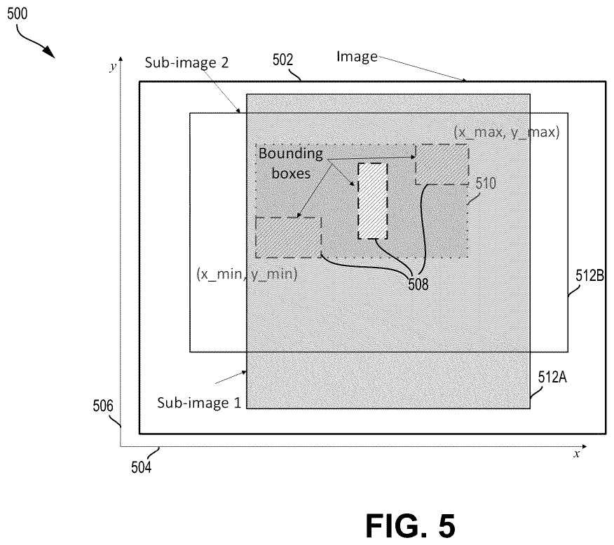

FIG. 5 illustrates sub-image generation 500, in accordance with aspects of the present disclosure. In some cases, sub-image generation 500 may be performed, for example, by the sub-image generation engine 412 of FIG. 4. As shown in FIG. 5, an image 502, such as a higher resolution image 410 of FIG. 4, may be associated with a horizontal axis 504 (e.g., x axis) and a vertical axis 506 (e.g., y-axis). As indicated above, indication(s) of where detected object(s) are in the original image may also be received. In some cases, these indication(s) may be a bounding box. In this example, three bounding boxes 508 are received and each bounding box may be associated with a set of coordinates, such as coordinates of a center of the bounding box, along with a width and height of the bounding box.

The bounding box may also be associated with confidence information and/or a classification for the object in the bounding box. In some cases, the bounding boxes may be filtered to remove bounding boxes associated with a lower confidence level than a threshold confidence level.

For the remaining bounding boxes (here bounding boxes 508), as indicated above, the bounding boxes 508 may be each associated with a set of coordinates (e.g., coordinates of the center, width and height and these coordinates may be converted from a coordinate system of the original image to a coordinate system of the higher resolution image 502. For example, where the original image is enlarged by a scaling factor of S, coordinates of the set of coordinates may be multiplied by the scaling factor to convert the coordinates of the bounding boxes 508 to the coordinate system of the higher resolution image 502. A minimum and maximum x and y values of the bounding boxes 508 may be found and these min/max x/y values of the bounding boxes 508 indicate the portion 510 of the image 502 that include all of the bounding boxes 508.

In some cases sub-images, such as a first sub-image 512A and a second sub-image 512B, may be defined based on the portion 510 of the image 502. For example, the portion 510 of the image 502 may be used as an anchor to generate the K number of sub-images such that each sub-image may include the portion 510. Sub-images may then be generated with a variety of aspect ratios to cover plausible arrangements of other instances of the objects. For example, a sub-image may be generated such that:

$$Δ {x}_{1} ∈ uniform ( 0 , {d}_{1} ) , Δ {x}_{2} ∈ uniform ( 0 , {d}_{1} )$$

$$Δ {y}_{1} ∈ uniform ( 0 , {d}_{2} ) , Δ {y}_{2} ∈ uniform ( 0 , {d}_{2} )$$

$${x}_{max}^{′} = min ( {x}_{max} + Δ {x}_{1} , SW )$$

$${x}_{min}^{′} = max ( {x}_{min} - Δ {x}_{2} , 0 )$$

$${y}_{max}^{′} = min ( {y}_{max} + Δ {y}_{1} , SH )$$

$${y}_{min}^{′} = max ( {y}_{min} - Δ {y}_{2} , 0 ) ,$$

where x₁ corresponds to an x axis value of the bounding box which includes the maximum x value, x₂ corresponds to an x axis value of the bounding box which includes the minimum x value, y₁ corresponds to a y axis value of the bounding box which includes the maximum y value, y₂ corresponds to a y axis value of the bounding box which includes the minimum y value, W corresponds to a width of the image 502, H corresponds to a height of the image 502, x′ₘₐₓ, x′ₘᵢₙ, y′ₘₐₓ, and y′ₘᵢₙ correspond to x and y values of the sub-image, and d corresponds to a value between 0 and (SW−x′ₘₐₓ)Δx ϵuniform {0, d}, Δx ϵuniform {0, (SW−xₘₐₓ}_. Other sub-images may also be generated using different values for d.

In some cases, the technique for object detection in relatively low quality and/or low-resolution images, such as from traffic cameras, may be performed with the assistance of edge and cloud computing to balance object detection performance and potential delays. For example, cloud computing may utilize computing resources accessible via the internet, typically located in a regional and/or national data centers. Cloud computing may offer high speed processing for executing ML models, but increase latency for transferring data to and from the cloud computing resources. Edge computing may refer to computing capabilities that may be closer to producers of the data to be processed (e.g., the traffic cameras). For example, edge computing may be performed by a computing device separate from the data producing device, where the computing device is located on a local network, internet service provider, content distribution network/service, or other computing resources provider, where the computing resources provider is located a fewer number of nodes (e.g., hops) away from the data producing device as compared to the cloud computing resources. The edge server (e.g., edge computing resources) may offer relatively less computational power as compared to the cloud server (e.g., cloud computing resources), but there may be less latency for transferring data to and from the edge server as compared to the cloud server. In some cases, portions of the technique for object detection discussed herein may be executed on the cloud or edge server. For example, the object detection ML model(s) 404, super resolution ML model(s), sub-image generation engine 412, object detection ML model(s) 416, sub-image coordinate transformation engine 418, and detection fusion engine 420 of FIG. 4 may be located on and/or executed by one or more cloud or edge servers.

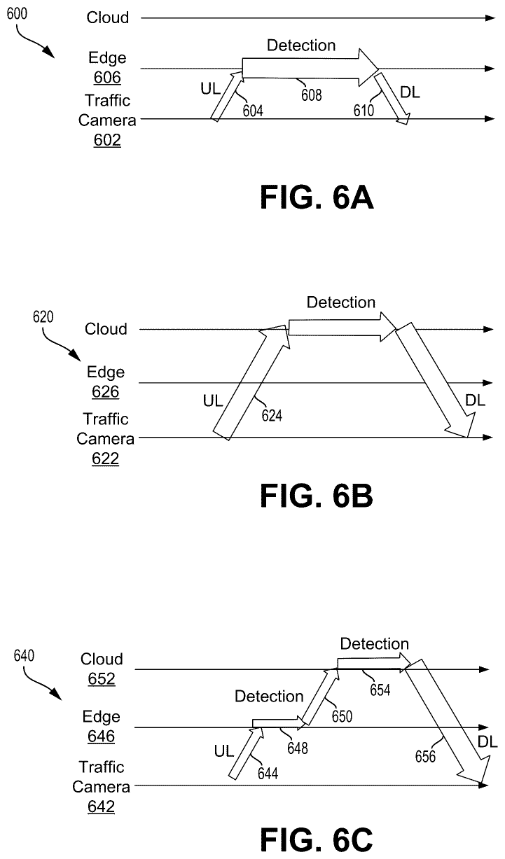

FIG. 6A illustrates a data flow 600 for executing the technique for object detection on edge servers, in accordance with aspects of the present disclosure. As shown in FIG. 6A, in some cases, a traffic camera 602 may capture images to be processed and the traffic camera 602 (or a device electronically coupled to the traffic camera 602) may upload 604 the captured images to an edge server 606 (e.g., edge computing service). In some cases, the traffic camera 602 may also upload a set of object detection parameters. The object detection parameters may indicate how object detection should be performed (e.g., configured) as the traffic camera 602 (or device coupled to the traffic camera 602) may have information about, for example, how the traffic camera 602 is configured, what ML models may be especially suited for data produced by the traffic camera, etc. For example, the object detection parameters may indicate one or more ML models that may be used as the object detection ML model(s) 404 and/or object detection ML model(s) 416, which ML model to use for the super resolution ML model 408, a scaling factor to use for the super resolution ML model 408, a filter threshold confidence level, a number K of sub-images that may be generated, and/or d values for the sub-image generation engine 412, and an indication of which fusion algorithm and corresponding parameters (such as a confidence threshold for NMS) which may be used for the detection fusion engine 420. After the images and object detection parameters are received by the edge server 606, the edge server 606 may perform object detection 608 as described above with respect to FIGS. 4 and 5 and output an indicated location of detected object(s) and a higher resolution image. The output from the object detection 608 may be sent 610 back to the traffic camera 602 and/or to an ADAS system, HD map service, or other third party.

FIG. 6B illustrates a data flow 620 for executing the technique for object detection on edge servers, in accordance with aspects of the present disclosure. As shown in FIG. 6B, in some cases, a traffic camera 622 may capture images to be processed and the traffic camera 622 (or a device electronically coupled to the traffic camera 602) may upload 624 the captured images and possibly the set of object detection parameters to a cloud server 626 (e.g., cloud computing service) for processing. In some cases, the cloud server 626 may process the images uploaded by the traffic camera 602 based on the set of object detection parameters in a manner substantially similar to that described above with respect to FIG. 6A.

FIG. 6C illustrates a data flow 640 for executing the technique for object detection using edge and cloud servers, in accordance with aspects of the present disclosure. As shown in FIG. 6C, in some cases, a traffic camera 642 may capture images to be processed and the traffic camera 642 (or a device electronically coupled to the traffic camera 642) may upload 644 the captured images and possibly the set of object detection parameters to an edge server 646 (e.g., edge computing service). The edge server 646 may then execute an object detection ML model (e.g., object detection ML model(s) 404 of FIG. 4) on the uploaded image based on the set of object detection parameters to perform detection 648. The edge server 646 may also execute a super resolution ML model (e.g., super resolution ML model 408 of FIG. 4) based on the set of object detection parameters to generate a higher resolution version of the uploaded image. The edge server 646 may then upload the output of the object detection ML model along with the set of object detection parameters (if available) and image (or higher resolution version of the image) to a cloud server 652. The cloud server 652 may execute a super resolution ML model based on the set of object detection parameters to generate a higher resolution version of the image (if not already generated by the edge server 646). The cloud server 652 may also generate sub-images (e.g., via sub-image generation engine 412 of FIG. 4), perform object detection for the sub-images (e.g., via object detection ML model 416), perform sub-image coordinate transforms (e.g., via sub-image coordinate transformation engine 418) and detection fusion (e.g., via detection fusion engine 420) to perform a portion of the object detection 654. The output from the object detection 654 may be sent 656 back to the traffic camera 602 and/or to an ADAS system, HD map service, or other third party.

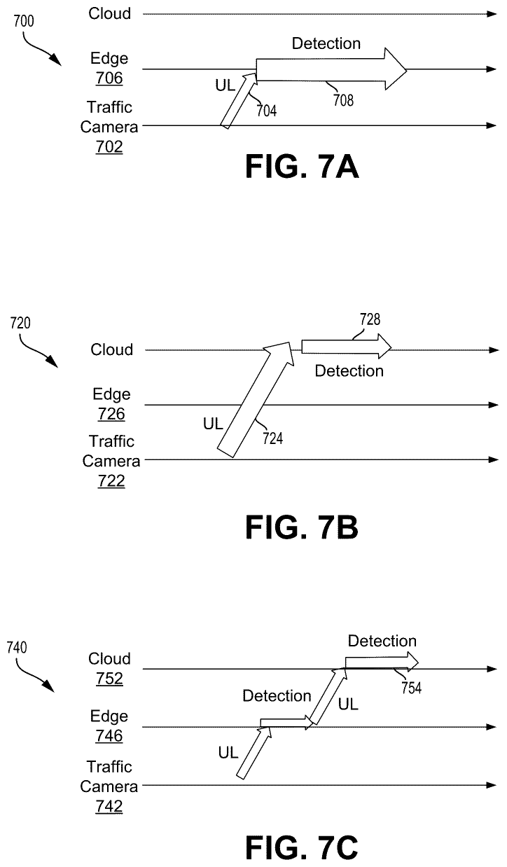

FIG. 7A illustrates a data flow 700 for executing the technique for object detection on edge servers where data regarding objects detected are used by the edge servers, in accordance with aspects of the present disclosure. In some cases, an edge server 706 may perform object detection and then use the data output from the object detection, for example, for further processing, such as for an ADAS system, HD map service, or other application. As shown in FIG. 7A, in some cases, a traffic camera 702 may capture images to be processed and the traffic camera 702 (or a device electronically coupled to the traffic camera 702) may upload 704 the captured images and possibly the set of object detection parameters to an edge server 706 (e.g., edge computing service). In some cases, the cloud server 726 may process the images uploaded by the traffic camera 702 based on the set of object detection parameters to perform object detection 708 in a manner substantially similar to that described above with respect to FIG. 6A. The output from the object detection 708 may be used by the edge server 706 for example, for further processing, such as for an ADAS system, HD map service, or other application.

FIG. 7B illustrates a data flow 720 for executing the technique for object detection on cloud servers where data regarding objects detected are used by the cloud servers, in accordance with aspects of the present disclosure. In some cases, a cloud server 726 may perform object detection and then use the data output from the object detection, for example, for further processing, such as for an ADAS system, HD map service, or other application. As shown in FIG. 7B, in some cases, a traffic camera 722 may capture images to be processed and the traffic camera 722 (or a device electronically coupled to the traffic camera 722) may upload 724 the captured images and possibly the set of object detection parameters to a cloud server 726 (e.g., cloud computing service) for processing. In some cases, the cloud server 726 may process the images uploaded by the traffic camera 722 based on the set of object detection parameters in a manner substantially similar to that described above with respect to FIG. 7A. The output from object detection 728 may be used by the cloud server 726 for example, for further processing, such as for an ADAS system, HD map service, or other application.

FIG. 7C illustrates a data flow 740 for executing the technique for object detection using edge and cloud servers where data regarding objects detected are used by the cloud servers, in accordance with aspects of the present disclosure. In some cases, an edge server 746 cloud server 752 may perform object detection and the cloud server 752 may use the data output from the object detection. In some cases, object detection by the edge server 746 and cloud server 752 based on images captured by a traffic camera 742 may be performed in a manner substantially similar to that described above with respect to FIG. 6C. The output from object detection 754 on the cloud server 752 may be used by the cloud server 752 for example, for further processing, such as for an ADAS system, HD map service, or other application.

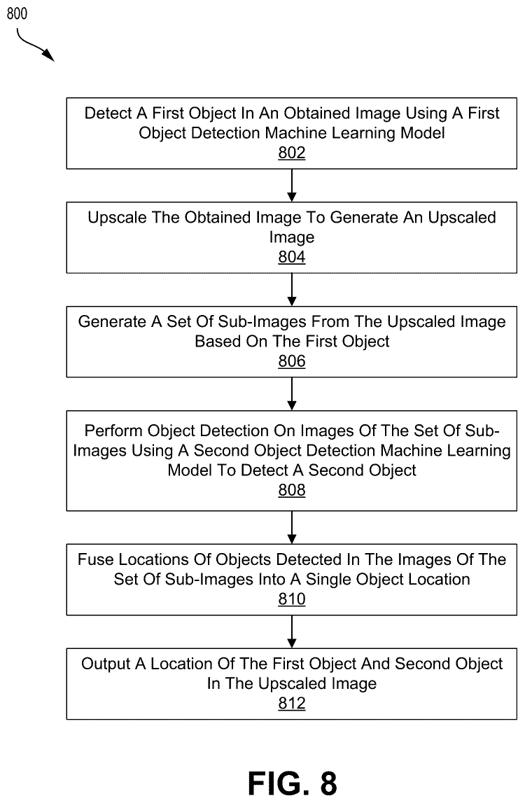

FIG. 8 is a flow diagram illustrating a process 800 for processing image data, in accordance with aspects of the present disclosure. The process 800 may be performed by a computing device (or apparatus) or a component (e.g., a chipset, codec, image processor 150, host processor 152, ISP 154 of FIG. 1, processor 910 of FIG. 9, etc.) of the computing device (e.g., image capturing and processing system 100 of FIG. 1, computing system 900 of FIG. 9). The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 800 may be implemented as software components that are executed and run on one or more processors (e.g., the image processor 150 of FIG. 1, the host processor 152, ISP 154 of FIG. 1, processor 910 of FIG. 9, and/or other processor(s)). In some cases, the operations of the process 800 can be implemented by a system having the architecture of computing system 900 of FIG. 9.

At block 802, the computing device (or component thereof) may detect a first object in an image using a first object detection machine learning model (e.g., fully connected neural network 202 of FIG. 2A, locally connected neural network 204 of FIG. 2B, convolutional neural network 206 of FIG. 2C, DCN 200 of FIG. 2D, deep convolutional network 350 of FIG. 3, object detection ML model 404 of FIG. 4, etc.).

At block 804, the computing device (or component thereof) may upscale the image to generate an upscaled image (e.g., higher resolution image 410 of FIG. 4). In some cases, the image is upscaled using an upscaling machine learning model based on a scaling factor (e.g., scaling factor of S). In some examples, the computing device (or component thereof) may receive an indication of a machine learning model to use as the upscaling machine learning model along with an indication of the scaling factor.

At block 806, the computing device (or component thereof) may generate a plurality of sub-images (e.g., sub-images 414 of FIG. 4) from the upscaled image based on the first object. For example, the sub-image generation engine may generate a number K of cropped sub-images from the higher resolution image based on a number of indicated detected objects in the original image. In some cases, the plurality of sub-images are generated based on locations of each relevant object detected in the image

At block 808, the computing device (or component thereof) may perform object detection on the plurality of sub-images using a second object detection machine learning model (e.g., object detection ML model(s) 416 of FIG. 4) to detect a second object. In some cases, the first object detection machine learning model and the second object detection machine learning model are a same object detection machine learning model. In some examples, the first object detection machine learning model and the second object detection machine learning model are different object detection machine learning models. In some cases, the first object detection machine learning model and the second object detection machine learning model are configurable. In some examples, the computing device (or component thereof) may receive a first indication of a first machine learning model to use as the first object detection machine learning model; and receive a second indication of a second machine learning model to use as the second object detection machine learning model. In some cases, the second object was missed by the first object detection machine learning model. In some examples, the second object detection machine learning model outputs a location of the second object relative to an image of the plurality of sub-images. In some cases, the computing device (or component thereof) may transform the location of the second object from a coordinate system relative to the image of the plurality of sub-images to a coordinate system relative to the upscaled image (e.g., by a sub-image coordinate transformation engine 418, see also FIG. 5).

At block 810, the computing device (or component thereof) may fuse locations (e.g., by a detection fusion engine 420 of FIG. 4) of objects detected in the plurality of sub-images into a single object location.

At block 812, the computing device (or component thereof) may output a location of the first object and second object in the upscaled image (e.g., higher resolution image 422 of FIG. 4).

FIG. 9 is a diagram illustrating an example of a system for implementing certain aspects of the present technology. In particular, FIG. 9 illustrates an example of computing system 900, which can be for example any computing device making up internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some examples, computing system 900 is a distributed system in which the functions described in this disclosure can be distributed within a datacenter, multiple data centers, a peer network, etc. In some examples, one or more of the described system components represents many such components each performing some or all of the functions for which the component is described. In some cases, the components can be physical or virtual devices.

Example computing system 900 includes at least one processing unit (CPU or processor) 910 and connection 905 that couples various system components including system memory 915, such as read-only memory (ROM) 920 and random access memory (RAM) 925 to processor 910. Computing system 900 can include a cache 912 of high-speed memory connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 may be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, camera, accelerometers, gyroscopes, etc. Computing system 900 can also include output device 935, which can be one or more of a number of output mechanisms. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission of wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.10 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some examples, a hardware service that performs a particular function can include the software component stored in a computer-readable medium in connection with the necessary hardware components, such as processor 910, connection 905, output device 935, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the examples provided herein. However, it will be understood by one of ordinary skill in the art that the examples may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples.

Individual examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the present disclosure include:

Aspect 1. An apparatus for image processing, comprising: at least one memory comprising instructions; and at least one processor coupled to the at least one memory, wherein the at least one processor is configured to: detect a first object in an image using a first object detection machine learning model; upscale the image to generate an upscaled image; generate a plurality of sub-images from the upscaled image based on the first object; perform object detection on the plurality of sub-images using a second object detection machine learning model to detect a second object; fuse locations of objects detected in the plurality of sub-images into a single object location; and output a location of the first object and second object in the upscaled image.

Aspect 2. The apparatus of Aspect 1, wherein the first object detection machine learning model and the second object detection machine learning model are a same object detection machine learning model.

Aspect 3. The apparatus of Aspect 1, wherein the first object detection machine learning model and the second object detection machine learning model are different object detection machine learning models.

Aspect 4. The apparatus of any of Aspects 1-3, wherein the second object was missed by the first object detection machine learning model.

Aspect 5. The apparatus of any of Aspects 1-4, wherein the second object detection machine learning model outputs a location of the second object relative to an image of the plurality of sub-images, and wherein the at least one processor is further configured to transform the location of the second object from a coordinate system relative to the image of the plurality of sub-images to a coordinate system relative to the upscaled image.

Aspect 6. The apparatus of any of Aspects 1-5, wherein the first object detection machine learning model and the second object detection machine learning model are configurable.

Aspect 7. The apparatus of Aspect 6, wherein the at least one processor is further configured to: receive a first indication of a first machine learning model to use as the first object detection machine learning model; and receive a second indication of a second machine learning model to use as the second object detection machine learning model.

Aspect 8. The apparatus of any of Aspects 1-7, wherein the image is upscaled using an upscaling machine learning model based on a scaling factor.

Aspect 9. The apparatus of Aspect 8, wherein the at least one processor is further configured to receive an indication of a machine learning model to use as the upscaling machine learning model along with an indication of the scaling factor.

Aspect 10. The apparatus of any of Aspects 1-9, wherein the plurality of sub-images is generated based on locations of each relevant object detected in the image.

Aspect 11. A method for image processing, comprising: detecting a first object in an image using a first object detection machine learning model; upscaling the image to generate an upscaled image; generating a plurality of sub-images from the upscaled image based on the first object; performing object detection on the plurality of sub-images using a second object detection machine learning model to detect a second object; fusing locations of objects detected in the plurality of sub-images into a single object location; and outputting a location of the first object and second object in the upscaled image.

Aspect 12. The method of Aspect 11, wherein the first object detection machine learning model and the second object detection machine learning model are a same object detection machine learning model.

Aspect 13. The method of Aspect 11, wherein the first object detection machine learning model and the second object detection machine learning model are different object detection machine learning models.

Aspect 14. The method of any of Aspects 11-13, wherein the second object was missed by the first object detection machine learning model.

Aspect 15. The method of any of Aspects 11-14, wherein the second object detection machine learning model outputs a location of the second object relative to an image of the plurality of sub-images, and further comprising transforming the location of the second object from a coordinate system relative to the image of the plurality of sub-images to a coordinate system relative to the upscaled image.

Aspect 16. The method of any of Aspects 11-15, wherein the first object detection machine learning model and the second object detection machine learning model are configurable.

Aspect 17. The method of Aspect 16, further comprising: receiving a first indication of a first machine learning model to use as the first object detection machine learning model; and receiving a second indication of a second machine learning model to use as the second object detection machine learning model.

Aspect 18. The method of any of Aspects 11-17, wherein the image is upscaled using an upscaling machine learning model based on a scaling factor.

Aspect 19. The method of Aspect 18, further comprising receiving an indication of a machine learning model to use as the upscaling machine learning model along with an indication of the scaling factor.

Aspect 20. The method of any of Aspects 11-19, wherein the plurality of sub-images is generated based on locations of each relevant object detected in the image.

Aspect 21. A non-transitory computer-readable medium having stored thereon instructions that, when executed by at least one processor, cause the at least one processor to: detect a first object in an image using a first object detection machine learning model; upscale the image to generate an upscaled image; generate a plurality of sub-images from the upscaled image based on the first object; perform object detection on the plurality of sub-images using a second object detection machine learning model to detect a second object; fuse locations of objects detected in the plurality of sub-images into a single object location; and output a location of the first object and second object in the upscaled image.

Aspect 22. The non-transitory computer-readable medium of Aspect 21, wherein the first object detection machine learning model and the second object detection machine learning model are a same object detection machine learning model.

Aspect 23. The non-transitory computer-readable medium of Aspect 21, wherein the first object detection machine learning model and the second object detection machine learning model are different object detection machine learning models.

Aspect 24. The non-transitory computer-readable medium of any of Aspects 21-23, wherein the second object was missed by the first object detection machine learning model.

Aspect 25. The non-transitory computer-readable medium of any of Aspects 21-24, wherein the second object detection machine learning model outputs a location of the second object relative to an image of the plurality of sub-images, and wherein the instructions cause the at least one processor to transform the location of the second object from a coordinate system relative to the image of the plurality of sub-images to a coordinate system relative to the upscaled image.

Aspect 26. The non-transitory computer-readable medium of any of Aspects 21-25, wherein the first object detection machine learning model and the second object detection machine learning model are configurable.

Aspect 27. The non-transitory computer-readable medium of Aspect 26, wherein the instructions cause the at least one processor to: receive a first indication of a first machine learning model to use as the first object detection machine learning model; and receive a second indication of a second machine learning model to use as the second object detection machine learning model.

Aspect 28. The non-transitory computer-readable medium of any of Aspects 21-27, wherein the image is upscaled using an upscaling machine learning model based on a scaling factor.

Aspect 29. The non-transitory computer-readable medium of Aspect 28, wherein the instructions cause the at least one processor to receive an indication of a machine learning model to use as the upscaling machine learning model along with an indication of the scaling factor.

Aspect 30. The non-transitory computer-readable medium of any of Aspects 21-29, wherein the plurality of sub-images is generated based on locations of each relevant object detected in the image.

Aspect 34: An apparatus for image generation, comprising means for performing one or more of operations according to any of Aspects 11 to 20.

What is claimed is:

1. An apparatus for image processing, comprising:
at least one memory comprising instructions; and
at least one processor coupled to the at least one memory, wherein the at least one processor is configured to:
detect a first object in an image using a first object detection machine learning model;
upscale the image to generate an upscaled image;
generate a plurality of sub-images from the upscaled image based on the first object;
perform object detection on the plurality of sub-images using a second object detection machine learning model to detect a second object;
fuse locations of objects detected in the plurality of sub-images into a single object location; and
output a location of the first object and second object in the upscaled image.

2. The apparatus of claim 1, wherein the first object detection machine learning model and the second object detection machine learning model are a same object detection machine learning model.

3. The apparatus of claim 1, wherein the first object detection machine learning model and the second object detection machine learning model are different object detection machine learning models.

4. The apparatus of claim 1, wherein the second object was missed by the first object detection machine learning model.

5. The apparatus of claim 1, wherein the second object detection machine learning model outputs a location of the second object relative to an image of the plurality of sub-images, and wherein the at least one processor is further configured to transform the location of the second object from a coordinate system relative to the image of the plurality of sub-images to a coordinate system relative to the upscaled image.

6. The apparatus of claim 1, wherein the first object detection machine learning model and the second object detection machine learning model are configurable.

7. The apparatus of claim 6, wherein the at least one processor is further configured to:
receive a first indication of a first machine learning model to use as the first object detection machine learning model; and
receive a second indication of a second machine learning model to use as the second object detection machine learning model.

8. The apparatus of claim 1, wherein the image is upscaled using an upscaling machine learning model based on a scaling factor.

9. The apparatus of claim 8, wherein the at least one processor is further configured to receive an indication of a machine learning model to use as the upscaling machine learning model along with an indication of the scaling factor.

10. The apparatus of claim 1, wherein the plurality of sub-images is generated based on locations of each relevant object detected in the image.

11. A method for image processing, comprising:
detecting a first object in an image using a first object detection machine learning model;
upscaling the image to generate an upscaled image;
generating a plurality of sub-images from the upscaled image based on the first object;
performing object detection on the plurality of sub-images using a second object detection machine learning model to detect a second object;
fusing locations of objects detected in the plurality of sub-images into a single object location; and
outputting a location of the first object and second object in the upscaled image.

12. The method of claim 11, wherein the first object detection machine learning model and the second object detection machine learning model are a same object detection machine learning model.

13. The method of claim 11, wherein the first object detection machine learning model and the second object detection machine learning model are different object detection machine learning models.

14. The method of claim 11, wherein the second object was missed by the first object detection machine learning model.

15. The method of claim 11, wherein the second object detection machine learning model outputs a location of the second object relative to an image of the plurality of sub-images, and further comprising transforming the location of the second object from a coordinate system relative to the image of the plurality of sub-images to a coordinate system relative to the upscaled image.

16. The method of claim 11, wherein the first object detection machine learning model and the second object detection machine learning model are configurable.

17. The method of claim 16, further comprising:
receiving a first indication of a first machine learning model to use as the first object detection machine learning model; and
receiving a second indication of a second machine learning model to use as the second object detection machine learning model.

18. The method of claim 11, wherein the image is upscaled using an upscaling machine learning model based on a scaling factor.

19. The method of claim 18, further comprising receiving an indication of a machine learning model to use as the upscaling machine learning model along with an indication of the scaling factor.

20. The method of claim 11, wherein the plurality of sub-images is generated based on locations of each relevant object detected in the image.

21. A non-transitory computer-readable medium having stored thereon instructions that, when executed by at least one processor, cause the at least one processor to:
detect a first object in an image using a first object detection machine learning model;
upscale the image to generate an upscaled image;
generate a plurality of sub-images from the upscaled image based on the first object;
perform object detection on the plurality of sub-images using a second object detection machine learning model to detect a second object;
fuse locations of objects detected in the plurality of sub-images into a single object location; and
output a location of the first object and second object in the upscaled image.

22. The non-transitory computer-readable medium of claim 21, wherein the first object detection machine learning model and the second object detection machine learning model are a same object detection machine learning model.

23. The non-transitory computer-readable medium of claim 21, wherein the first object detection machine learning model and the second object detection machine learning model are different object detection machine learning models.

24. The non-transitory computer-readable medium of claim 21, wherein the second object was missed by the first object detection machine learning model.

25. The non-transitory computer-readable medium of claim 21, wherein the second object detection machine learning model outputs a location of the second object relative to an image of the plurality of sub-images, and wherein the instructions cause the at least one processor to transform the location of the second object from a coordinate system relative to the image of the plurality of sub-images to a coordinate system relative to the upscaled image.

26. The non-transitory computer-readable medium of claim 21, wherein the first object detection machine learning model and the second object detection machine learning model are configurable.

27. The non-transitory computer-readable medium of claim 26, wherein the instructions cause the at least one processor to:
receive a first indication of a first machine learning model to use as the first object detection machine learning model; and
receive a second indication of a second machine learning model to use as the second object detection machine learning model.

28. The non-transitory computer-readable medium of claim 21, wherein the image is upscaled using an upscaling machine learning model based on a scaling factor.

29. The non-transitory computer-readable medium of claim 28, wherein the instructions cause the at least one processor to receive an indication of a machine learning model to use as the upscaling machine learning model along with an indication of the scaling factor.

30. The non-transitory computer-readable medium of claim 21, wherein the plurality of sub-images is generated based on locations of each relevant object detected in the image.
